(19) United States
(12) Patent Application Publication
(10) Pub. No.: US 2022/0223874 A1
(43) Pub. Date: Jul. 14, 2022

(54) Multifunctional Cross-linked Binders for Lithium-Sulfur Battery Cathodes

(71) Applicant: University of Waterloo, Waterloo (CA)

(72) Inventors: Linda Faye NAZAR, Waterloo (CA); Chun Yuen KWOK, Scarborough (CA); Mario GAUTHIER, Waterloo (CA)

(73) Assignee: University of Waterloo, Waterloo, ON (CA)

(21) Appl. No.: 17/595,720

(22) PCT Filed: May 25, 2020
(86) PCT No.: PCT/CA2020/050709

§ 371 Date: Nov. 23, 2021

Related U.S. Application Data
(60) Provisional application No. 62/920,942, filed on May 24, 2019.

(51) Int. Cl. H01M 4/62; H01M 10/0525; H01M 4/58

(52) U.S. Cl. CPC H01M 4/622; H01M 10/0525; H01M 2004/028; H01M 4/625; H01M 4/5815

(57) ABSTRACT

Disclosed is an electrochemical cell comprising a lithium-based anode and a sulfur-based cathode and an electrolyte, wherein the cathode material comprises a polymeric binder, wherein the binder comprises ammonium functional groups. In one aspect, the polymeric binder comprises ammonium chloride functional groups.

### CROSS REFERENCE TO RELATED APPLICATIONS

This application claims priority under the Paris Convention to U.S. Application No. 62/920,942, filed on May 24, 2019. The entire content of such prior application is incorporated herein by reference as if set forth in its entirety.

### STATEMENT REGARDING FEDERALLY SPONSORED RESEARCH OR DEVELOPMENT

This invention was made with government support under Contract No. DOE-FOA-0000559, Energy Innovation Hub—Batteries and Energy Storage, and [ANL Subcontract No. 3F-32281], issued under DOE Prime Contract No. DE-AC02-06CH11357 between the United States Government and UChicago Argonne, LLC representing Argonne National Laboratory. The United States Government has certain rights in the invention.

### FIELD OF THE DESCRIPTION

The present description generally relates to cathodes for lithium-sulfur (Li—S) batteries. In particular, the description relates to cathodes fabricated with a binder comprising ammonium, and more particularly, ammonium chloride functional groups.

### BACKGROUND

The rising demands in advanced energy storage devices for electric vehicles, unmanned aerial vehicles and robots call for forward-looking battery technologies that can exceed the specific energy afforded by intercalation chemistry. An approach based on lithium-sulfur (Li—S) conversion chemistry is promising for next generation electrochemical batteries, due to sulfur's high theoretical specific capacity of 1675 mA·h·g⁻¹ and energy density of 2800 W·h·L₋₁. The high natural abundance and innocuity of sulfur further contributes to the low cost and appeal of such a system.

The commercialization of Li—S batteries, however, has been plagued by low areal sulfur loading, poor sulfur utilization, and capacity degradation. These drawbacks originate from the dissolution and “shuttling” of lithium polysulfides (which leads to leakage of active material from the cathode, resulting in reduced life cycle of the battery), a large volume change in the cathode during cycling (which places mechanical stresses on the cathode and also results in reduced life cycle of the battery), and a lengthened electronic/ionic pathway in thick electrodes. Considerable effort has been devoted toward the optimization of cell components, including the development of new host materials, separators, and electrolytes. Despite these recent advances, fabricating a high areal capacity, stable-cycling Li—S battery still remains a major challenge. Low-sulfur loading (<2 mg·cm⁻¹) Li—S cells are often reported, whereas achieving high-sulfur loading cells with a practical electrolyte/sulfur ratio is critical to maximizing cell energy density. Although constructing a 3D carbon network on an electrode enables very high sulfur loading, the large voids in these structures require excess electrolyte to fully wet the electrode, thus compromising the overall energy density. Casting active materials on the current collector by a traditional slurry process is a more viable avenue, as it maximizes the packing efficiency and is commensurate with current industrial protocols. However, this process requires the use of functional binders to provide an elastic interface for the essential cathode components to prevent them from delaminating from the cathode over extensive cycling.

Binders are polymers that hold the critical components of the electrode together during redox cycling. Their primary functions are to (1) bridge individual particles together with the current collector; (2) assist the carbon additive to maintain electronic contact upon cycling; (3) facilitate Li⁺ ion transport at the electrode-electrolyte interface; and (4) provide chemical interactions to improve electrochemical performance. Although the binder often contributes as much as 10% of the overall cathode weight, its vital function is usually overlooked in Li—S cathodes. Examples of Li—S cells having cathodes fabricated with polymeric binders are described, for example, in US 2018/0198164, US 2018/0047980, and U.S. Pat. No. 8,663,840.

Poly(vinylidene fluoride) (PVDF) binder is conventionally used due to its excellent thermomechanical properties and adhesion to the cathode materials in lithium ion batteries. However, as Li—S chemistry is haunted by polysulfide dissolution, it is highly desirable to instead arm the binder with active functional groups to bind these intermediates. This was demonstrated in early studies that showed such modified binders exhibit improved cyclability in comparison with PVDF. The performance enhancement was attributed to amine, hydroxyl, carboxyl, and carboxylic groups interacting with lithium polysulfides in these polymers. Nonetheless, the binding energy of these functional groups was still too weak to suppress polysulfide shuttling, and the sulfur loading in these reports was far too low for any practical applications. Only recently have a few studies focussed on designing new binder systems for thick electrodes, exemplified by styrene-butadiene rubber, polyethylenimine, polyamidoamine dendrimers, gums, and cross-linked elastomeric carboxymethyl cellulose. Another report demonstrated that a cationic polyelectrolyte binder is very effective at restricting polysulfide diffusion from the host sulfur/sulfide cathode. In parallel, researchers are starting to recognize the importance of the mechanical properties of binders to maintain the structural integrity of multi-component U—S cathodes. However, there still remains a lack of understanding on the impact of the binder's characteristics in addressing the continuous volume expansion/contraction experienced during Li—S cell cycling.

### SUMMARY OF THE DESCRIPTION

In one aspect, the present description provides new ammonium chloride-based cross-linked binders. In particular, the binders are suited for use in fabricating electrodes, in particular cathodes, for Li—S cells.

In one aspect, there is provided a cathode for a lithium-sulfur cell, the cathode comprising: one or more cathode active materials, comprising sulfur and/or sulfur-based materials; one or more conductive materials; and, at least one binder, wherein the binder comprises a polymeric material having ammonium functional groups.

In another aspect, there is provided a cathode composition for forming a cathode for a lithium-sulfur battery, the cathode material comprising: one or more cathode active materials, comprising sulfur and/or sulfur-based materials; one or more conductive materials; and, at least one binder, wherein the binder comprises a polymeric material having ammonium functional groups. Also provided are cathodes formed with such composition.

In other aspects, the ammonium functional groups are ammonium chloride groups and/or wherein the one or more conductive materials comprise carbon and/or carbon-based materials.

In another aspect, there is provided a Li—S cell incorporating cathodes as described above.

### BRIEF DESCRIPTION OF THE FIGURES

The features of certain embodiments will become more apparent in the following detailed description in which reference is made to the appended figures wherein:

FIGS. 1 and 2 illustrate the synthesis of cross-linked polymers via radical polymerization. The figure illustrates a schematic representation of the cross-linker (EGDA) that is copolymerized with AETMAC (FIG. 1) and DADMAC (FIG. 2) to form three-dimensional polymeric networks.

FIGS. 3 and 4 illustrate, respectively, FTIR spectra for the highly cross-linked polymeric binders, namely poly(AETMAC-co-EGDA) (FIG. 3) and poly(DADMAC-co-EGDA) (FIG. 4).

FIGS. 5a to 5d illustrate chemical interactions between functional groups present in the binder studied and lithium polysulfide. FTIR spectra of Li₂S₄ (top trace); pristine homopolymer (bottom trace); and solids recovered from homopolymer-Li₂S₄ suspension (middle trace) for poly(AETMAC) (Figure Sa); poly(DADMAC) (FIG. 5b); poly(EGDA) (Figure Sc); and PVDF (FIG. 5d).

FIG. 6 illustrates a summary of calculated polysulfide adsorptivity per 10 mg of PVDF, poly(DADMAC-co-EGDA), and poly(AETMAC-co-EGDA). In each case, the upper bar represents Li₂S₄ and the darker colour represents Li₂S₈.

FIGS. 7 and 8 illustrate, respectively, the electrochemical profiles (C/20) and the discharge capacities at different C-rates for sulfur cathodes fabricated with: poly(AETMAC-co-EGDA) (I), poly(DADMAC-co-EGDA) (II), and PVDF (III) at a low sulfur loading of ˜3.5 mg·cm⁻².

FIG. 9 illustrates the long-term cycling stability (C/5) of the electrodes described in FIGS. 7 and 8.

FIG. 10 to 12 illustrate the mechanical characterization of the polymeric binders to simulate the sulfur electrode environment in Li—S cells. FIG. 10 illustrates time-dependent swelling profiles for poly(AETMAC-co-EGDA) (I); poly(DADMAC-co-EGDA) (II); and PVDF (III) in an electrolyte solvent (DOL:DME, 1:1 v/v). FIG. 11 illustrates the tensile stress-strain results using the subject polymeric binders. FIG. 12 illustrates the toughness of sulfur cathodes using the subject polymeric binders on P50 carbon paper, until facture.

FIG. 13 are SEM images of the surface of the sulfur cathodes before (FIGS. 13a to 13c) and after (FIGS. 13d to 13f) 100 cycles. FIGS. 13a and 13d illustrate cathodes fabricated with PVDF. FIGS. 13b and 13e illustrate cathodes fabricated with poly(DADMAC-co-EGDA). FIGS. 13c and 13f illustrate cathodes fabricated with poly(AETMAC-co-EGDA).

FIG. 14 to 16 illustrate electrochemical profiles (C/50) for the sulfur cathodes fabricated with poly(AETMAC-co-EGDA) (I), poly(DADMAC-co-EGDA) (II), and PVDF (III) at high sulfur loading (˜6.0 mg·cm⁻²). FIG. 14 illustrates the discharge/charge voltage profile as a function of mass-specific capacity. FIG. 15 illustrates the discharge/charge voltage profile as a function of areal capacity. FIG. 16 illustrates the long-term cycling profile for the same sulfur cathodes at a current rate of C/10.

FIG. 17 is a schematic illustration of the cathode structure according to an aspect of the description fabricated with poly(AETMAC-co-EGDA).

### DETAILED DESCRIPTION

The terms “comprise”, “comprises”, “comprised” or “comprising” may be used in the present description. As used herein (including the specification and/or the claims), these terms are to be interpreted as open-ended terms and as specifying the presence of the stated features, integers, steps or components, but not as precluding the presence of one or more other feature, integer, step, component or a group thereof as would be apparent to persons having ordinary skill in the relevant art. Thus, the term “comprising” as used in this specification means “consisting at least in part of”. When interpreting statements in this specification that include that term, the features, prefaced by that term in each statement, all need to be present but other features can also be present. Related terms such as “comprise” and “comprised” are to be interpreted in the same manner.

The phrase “consisting essentially of” or “consists essentially of” will be understood as generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. When using an open-ended term, such as “comprising” or “including”, it will be understood that direct support should be afforded also to “consisting essentially of” language as well as “consisting of” language as if stated explicitly and vice versa. In essence, use of one of these terms in the specification provides support for all of the others.

The term “and/or” can mean “and” or “or”.

Unless stated otherwise herein, the articles “a” and “the”, when used to identify an element, are not intended to constitute a limitation of just one and will, instead, be understood to mean “at least one” or“one or more”.

The present description is generally directed to lithium-sulfur (or lithium-sulfide) batteries, or cells, comprising a lithium-based anode and a sulfur-based cathode. Anode materials usable in the present cells can be any material known it the art. For example, the anode material can include at least one anode active material, at least one binder additive, and at least one conductive additive. The materials may be provided on substrate. The conductive additive may comprise any material known in the art, including but not limited to carbon materials. Such carbon materials may include graphite carbon, graphite and other acetylene polymeric materials oxidized at high temperatures to provide the carbon component. Other carbon materials including pyrolytic carbon, coke, sintered organic polymer and activated carbon can be incorporated. In other instances, organic polymers sintered by phenolic resin, epoxy resin or having sintered by carbonization may also be contemplated. The carbon materials may comprise one or more of carbon black, carbon spheres, and carbon nanotubes. The present description is not limited to any particular anode material or materials.

The cathodes described herein may comprise any structure as may be known in the art. Generally, the cathodes described herein comprise sulfur and/or sulfur-based compounds and conductive materials as may be typically used, such as carbon and/or carbon-based materials such as mentioned above. In one aspect, the carbon materials comprise one or more of carbon black, carbon spheres, and carbon nanotubes.

The cells described herein will also be understood to comprise an electrolyte. Electrolytes usable herein may be any electrolyte material known in the art that is usable for Li—S cells.

As discussed above, the components making up an electrode, i.e. anode and cathode, are generally maintained together by means of a binder. Such binders are known in the art. However, described herein, according to one aspect, are new ammonium chloride-based cross-linked binders that are ideally suited for electrodes, in particular cathodes, of a Li—S battery. In one aspect, the binders described herein exhibit strong interaction with lithium polysulfides and thereby contribute to the suppression of polysulfide shuttling. In another aspect, the binders described herein exhibit optimal interfacial and mechanical properties that allow stable cycling of high-sulfur loading cathodes.

The strong charge-transfer interactions between the ammonium cation and polysulfide anion and the consequent molecular reorganization of these species was demonstrated by spectroscopic and electrochemical studies. More importantly, we correlated the electrochemical performance of sulfur cathodes with the mechanical properties of three different polymeric binders, including one similar in chemical functionality but with lower tensile strength. Our results showed that cross-linked polymers with a low swelling ratio and a high tensile strength, Young's modulus, and toughness are critical for delamination tolerance. Furthermore, excellent compatibility of the polymer binder with the selected casting solvent allows the utilization of a conventional slurry process to construct mechanically stable electrodes. Using this approach, it was found that a high-sulfur loading (6.0 mg·cm⁻²) Li—S cell utilizing a low electrolyte/sulfur ratio of 7:1 (μL:mg) can be cycled for at least 300 cycles with a low capacity fade rate.

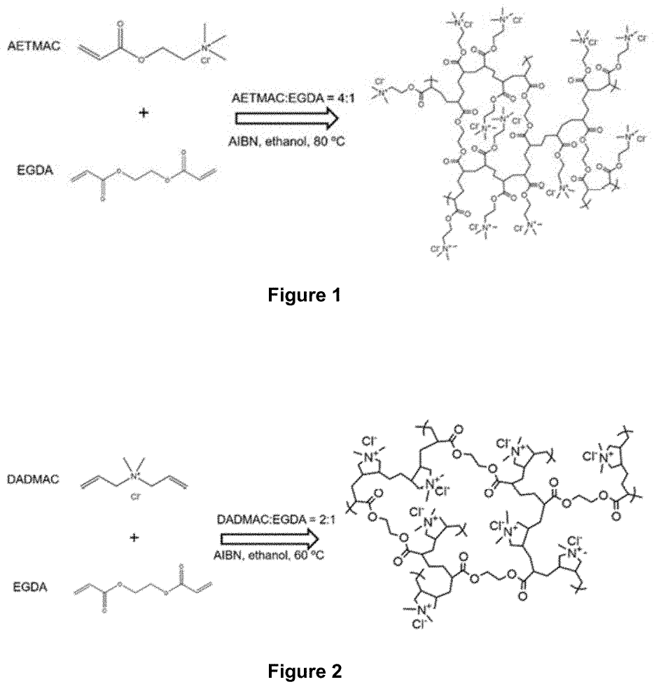

Described herein are compositions and methods of synthesis relating to multifunctional cross-linked ammonium-based polymeric binders that confine the above-mentioned soluble polysulfide species and have the desired mechanical properties to allow stable cycling of high-sulfur loading cathodes for lithium-sulfur (Li—S) batteries. In particular, two examples of such binders were investigated, namely: (i) “poly(AETMAC-co-EGDA)”, which is formed from [2-(acryloyloxy)ethyt]trimethylammonium chloride (AETMAC) monomers cross-linked with ethylene glycol diacrylate (EGDA) (FIG. 1); and, (ii) “poly(DADMAC-co-EGDA)”, which is formed from diallyldimethylammonium chloride (DADMAC) monomers cross-linked with ethylene glycol diacrylate (EGDA) (FIG. 2).

Materials and Methods

### Preparation of Poly(AETMAC-Co-EGDA) Cross-Linked Polymer

Free-radical polymerization was employed to cross-link AETMAC and EGDA in 80° C. in dry ethanol. The molar ratio between the monomer and the cross-linker was maintained at 4:1. AETMAC (80 wt. % in H₂O, Sigma-Aldrich) containing 600 ppm monomethyl ether hydroquinone inhibitor was first passed through an inhibitor-remover column (Sigma-Aldrich) twice prior to use. Next, 804 mg of the purified AETMAC aqueous solution, 157 mg EGDA (90% technical, Sigma-Aldrich), and 39 mg AIBN (99%, recrystallized, Sigma-Aldrich), and 4 g dry ethanol (Fisher Scientific) were introduced to a 50 mL round-bottomed flask. The flask was sealed with a rubber septum and the mixture was stirred rapidly for 15 minutes. After a clear solution was obtained, the mixture was purged gently with dry nitrogen for an additional 10 minutes before placing the flask in an oil bath (80° C.) on a stir plate. The stirred reaction was terminated after 12 hours, and the cross-linked polymer was recovered by precipitation in acetone (ACS, Sigma-Aldrich). Finally, the polymer was filtered and rinsed with cold isopropanol (anhydrous, Sigma-Aldrich) to remove any unreacted precursors.

### Preparation of Poly(DADMAC-Co-EGDA) Cross-Linked Polymer

The free radical cross-linking polymerization between DADMAC and EGDA was achieved in a similar manner to the experimental procedure described above. However, the copolymerization temperature for poly(DADMAC-co-EGDA) was set to 60° C. and the molar ratio of monomer to cross-linker was 2:1. In a typical procedure, a mixture of 604 mg DADMAC (97% AT, Sigma-Aldrich), 353 mg EGDA, 44 mg AIBN, and 4 g anhydrous ethanol in a 50 mL round-bottomed flask was used for the reaction. The flask was sealed with a rubber septum, and the mixture was stirred for at least 15 minutes to allow dissolution of the reactants; the solution was then purged gently with dry nitrogen for 10 minutes. The flask was placed in an oil bath (60° C.) and the mixture was stirred for 12 hours, although the contents turned cloudy 10 minutes after the start of polymerization. Finally, the cross-linked polymer was filtered and rinsed with cold isopropanol to remove any unreacted precursors.

### Preparation of the Porous Hollow Carbon Sphere (PHCS) Sulfur Host

The host material was synthesized as previously reported. Elemental sulfur was melt-diffused into the PHCSs at 160° C. for 12 hours to afford the S-PHCS composite, with a sulfur content of 75 wt. % as determined by TGA.

### Preparation of Li₂Sₙ

In an Ar-filled glovebox, Li₂S₄ and Li₂S₆ were synthesized by allowing elemental sulfur (99.5%, Sigma-Aldrich) to react with lithium triethylborohydride (1M, Sigma-Aldrich) in anhydrous tetrahydrofuran in the appropriate stoichiometric ratio. The resultant solution was vacuum dried, followed by a final wash with toluene to isolate the powders. The lithium polysulfide powder was collected by vacuum drying in a Büchi™ vacuum oven at 60° C. for 6 hours.

### Preparation of the Li₂S₄-Homopolymer Mixture

All the solid materials were vacuum dried in a Büchi™ vacuum oven at 60° C. for 24 hours prior to use. In an Ar-filled glovebox, 20 mg homopolymer and 20 mg Li₂S₄ were stirred in 2 mL DME for 6 hours. The material for FTIR analysis was collected by centrifugation (10 kRPM, 10 min) followed by vacuum drying overnight.

### Lithium Polysulfide Adsorptivity Measurement

The adsorptivity of lithium polysulfides onto the polymeric binders was determined by an electrochemical sulfur titration technique. In an Ar-filled glovebox, the binders and lithium polysulfide (Li₂S₄ or Li₂S₆) powders were stirred in DME at a concentration of 10 mg·mL⁻¹ for 18 hours to allow saturation of the materials with Sn²⁻. The suspension was then centrifuged (10 kRPM, 10 min) to remove the solid powders. The supernatant was collected and further diluted with 2M LiTFSI in DME, utilizing a stainless-steel current collector (type 316, 100 mesh, Alfa Aesar). The counter electrode compartment was filled with 1M LiTFSI in DME and 2 wt. % LiNO₃. A porous glass frit was used to separate the two solutions in a two-electrode Swagelok® cell. The oxidation potential of the sample solution was held at 3.0 V vs. Li/Li⁺ in order to oxidize the excess lithium polysulfide to elemental sulfur, and the capacity was determined by integrating the time needed for the current to reach essentially zero. Lithium polysulfide solutions were also prepared in the absence of binders to establish a standard curve.

Tensile Tests

The P50 carbon paper samples with the composite material coated in the same manner as for electrode preparation were cut into 3″×1″ rectangular shapes and mounted via grip heads. Mechanical tests were carried out on a universal macro-tribometer (UNMT-2MT, Centre for Tribology, Inc.) with a 10 kg load cell. The force and displacement were controlled by a step-motor at a pull rate of 0.01 mm·s⁻¹.

Physical Characterization

FTIR spectra were obtained on a Bruker Tensor™ 37 spectrometer. For polysulfide-contact experiments, the samples were mixed with KBr in an Ar-filled glovebox before transfer to a N₂-filled chamber where the analysis was conducted. Lithium polysulfide adsorptivity was measured on a VMP3™ multi-channel potentiostat (Bio-logic) by chronoamperometry. SEM and EDAX elemental analysis studies were carried out on a Zeiss Ultra field emission SEM instrument equipped with an EDX attachment (Zeiss). TEM was performed on a ZEISS Libra 200 MC TEM instrument operating at 200 kV. The specific surface area and pore volume were measured using a Quantachrome Autosorb-1™ system at 77 K. The specific surface area and pore size distribution were calculated by the Brunauer-Emmett-Teller method and the quenched solid density functional theory method, respectively. TGA, used to determine the sulfur content of the materials, was carried out on a TA Instruments SDT Q600M at a heating rate of 10° C.·min⁻¹ from room temperature to 800° C. under airflow.

Electrode Preparation

The electrodes were prepared from a waterdimethylformamide (6:4) slurry containing 80 wt. % S-PHCS, 5 wt. % Super P® carbon black, 5 wt. % 8 nm multiwall carbon nanotubes, and 10 wt. % polymeric binder onto P50 carbon paper. Only dimethytformamide was used when PVDF served as binder. The sulfur loading on these electrodes was either 3.5 or 6.0 mg·cm². The electrodes were dried in a 60° C. oven for 24 hours before they were transferred to an Ar-filled glovebox. Li—S coin cells (2325) were assembled with a lithium foil anode and an electrolyte of 1M lithium bis(trifluoromethanesulfonyl)imide (LiTFSI) and 2 wt. % UNO₃ in a 1:1 v/v mixture of 1,2-dimethoxyethane (DME) and 1,3-dioxolane (DOL) (BASF). The electrolyte/sulfur ratio was 7:1 (μL:mg) for the electrochemical studies. Cycling performance and rate capability studies were performed on a multi-channel Arbin instrument. Electrochemical impedance spectroscopy was recorded on a Biologic VMP3m electrochemical station with amplitude of 10 mV in the frequency range of 200 MHz to 500 kHz.

Results and Discussion

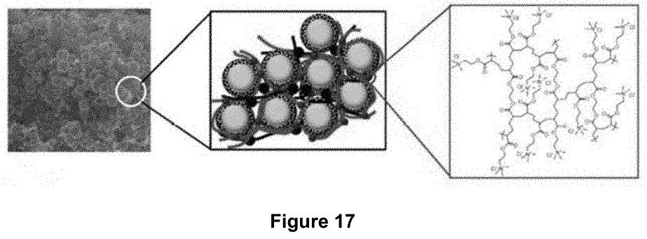

As noted above, two cross-linked polymers based on ammonium chloride functional groups were prepared via radical polymerization. Ethylene glycol diacrylate (EGDA) was used as the cross-linking agent to copolymerize with either [2-(acryloyloxy)ethyl]trimethylammonium chloride (AETMAC) (FIG. 1) or diallyldimethylammonium chloride (DADMAC) monomers (FIG. 2) to fabricate a three-dimensional polymeric network. These polymers are referred to herein as poly(AETMAC-co-EGDA) and poly(DADMAC-co-EGDA), respectively. FIG. 17 schematically illustrates the structure of a cathode fabricated with polymers described herein, in particular with poly(AETMAC-co-EGDA.

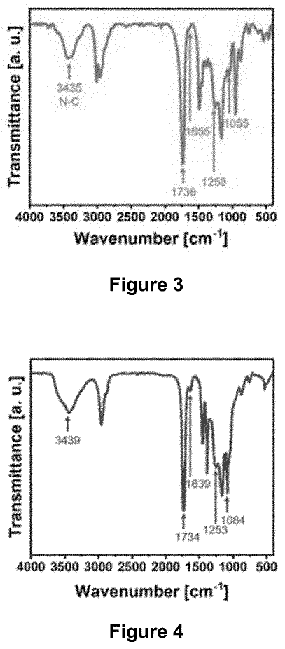

The two cross-linked polymers were found to have similar functional groups in their subunits that were found to regulate lithium polysulfide transport in the electrolyte, thereby making them ideal candidates for use in Li—S cells. However, these polymers were also found to exhibit different mechanical properties due to differences in the reactivity of the monomers with EGDA, which controls the density of the cross-linked network. The density was optimized with respect to their electrochemical performance as binders in Li—S cells. Successful cross-linking copolymerization was confirmed by the insolubility of the products in water, unlike the monomers which are highly soluble. Their Fourier transform infrared (FTIR) spectra, shown in FIGS. 3 and 4, respectively, show bands typical for the functional groups as described in the literature.

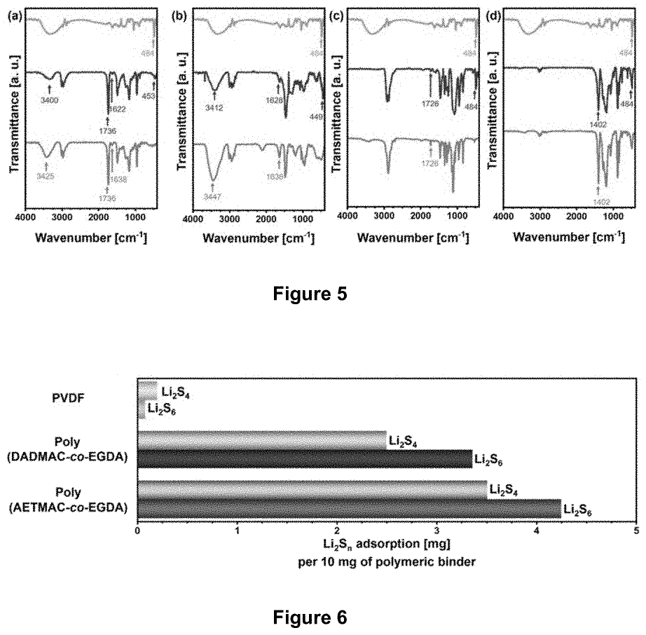

The interactions between the functional groups in the polymer binders and lithium polysulfides (as represented by Li₂S₄) were examined by FTIR spectroscopy, to elucidate the mechanism of the charge-transfer binding effect. The N—C moieties (at 3400 and 1640 cm⁻¹) and the ester C═O moieties (1700 cm-1) are potential indicators of this process. Homopolymers were mixed with Li2S4 powders dissolved in DME, and the solids were extracted for FTIR analysis (as described above). The FTIR spectra obtained forthe pristine homopolymer and Li2S4, as well as the homopolymer-Li2S4 mixtures with poly(AETMAC), poly(DADMAC), poly(EGDA), and PVDF were compared and the results are illustrated in FIGS. 5a to 5d. Homopolymers were used in this analysis to ensure that the interactions observed in the FTIR spectra are only attributed to specific functional groups. The pristine poly(AETMAC) in FIG. 5a exhibits a sharp peak at 1638 cm⁻¹ and a broad band at 3425 cm⁻¹, corresponding to the unsaturated primary amine and C—N stretching vibrations in the secondary amine group, respectively. Upon contact with Li₂S₄, these peaks shifted to much lower wavenumbers of 1622 and 3400 cm⁻¹, and their intensity significantly decreased. Similarly for poly(DADMAC), these bands also shifted by about 10 cm⁻¹ (from 1636 to 1628 cm⁻¹ and from 3447 to 3412 cm⁻¹) when blended with Li₂S₄(FIG. 5b). In addition, rearrangement of the sulfur-chain in the polysulfide was observed, as signified by a shift in the symmetrical S—S band from 484 cm⁻¹ to 453 cm⁻¹ and 449 cm⁻¹ in the poly(AETMAC)—Li₂S₄ and poly(DADMAC)-Li₂S₄ materials, respectively. All these molecular rearrangements, delineated by the shifts in their respective FTIR spectra, indicate charge transfer takes place between the ammonium cations and the polysulfide anions. It is believed that the acidic character of the ammonium cations enables their direct electrostatic binding to the polysulfide anions. This interaction causes the original N—H and S—S bond lengths to increase as a result of bond weakening. Thus, a red-shift in their FTIR spectra is observed, as illustrated in the middle trace shown in FIGS. 5a and 5b. However, no such shifts were observed in vibrational modes associated with carbonyl groups, likely because the carbonyl groups instead bind to lithium ions via the oxygen empty 2 p orbital. Such indirect interactions do not disturb the S—S and C═O bonds, as seen in the invariant sharp peak ascribed to the ester C═O bond in poly(AETMAC) (1736 cm⁻¹, FIG. 5a) or poly(EGDA) (1726 cm⁻¹, FIG. 5c). Of course, the fluoride group in PVDF (FIG. 5d) cannot engage in any interactions with lithium polysulfide. Accordingly, the PVDF-Li₂S₄ materials show only features characteristic for polysulfide and a C—F asymmetric stretching band (1402 cm⁻¹).

In light of the interactions described above, we further examined the polysulfide adsorptivity of these binders via a facile titration technique—electro-oxidization of polysulfides. Although lithium polysulfides are known to disassociate in glyme, Li₂S₄ and Li₂S₆ are the most prevalent species during sulfur redox and were hence selected as representative probe molecules. Each binder material was accurately weighed into a stock solution of Li₂S₄ or Li₂S₆ in DME. The supernatant was then collected and subjected to electrochemical titration of the remaining Li₂Sₙ in solution, as noted above. Knowledge of the concentration in the stock solution of Li₂S₄ and Li₂S₆ enabled the determination of the amount of Li₂Sₙ removed from the supernatant via adsorption onto the binder material.

The absorptivity of Li₂S₄ and Li₂S₆ on PVDF, poly(DADMAC-co-EGDA), and poly(AETMAC-co-EGDA) is summarized in FIG. 6. Unsurprisingly, PVDF was found to adsorb much less Li₂Sₙ compared with the two cross-linked polymers. These results are in strong agreement with the FTIR analysis, showing there are no chemical interactions between the fluoride moieties and lithium polysulfides. On the other hand, the ammonium subunits in both poly(AETMAC-co-EGDA) and poly(DADMAC-co-EGDA) network engage in acid-base interactions with the polysulfide anions. Both of these cross-linked polymer binders exhibited comparable polysulfide adsorptivity to some cathode host materials which have demonstrated a superior ability to readily bind polysulfides.

Further correlation can be drawn between Li₂Sₙ adsorptivity on the cross-linked polymers and the chain-length of the polysulfides. Both poly(AETMAC-co-EGDA) and poly(DADMAC-co-EGDA) have a higher affinity toward the higher order hexasulfide than the tetrasulfide. Poly(AETMAC-co-EGDA) features the highest adsorptivity (4.25 mg L₂S₆ per 10 mg of polymer). Recent work by Li et al., also showed that lithium ions are less tightly bound to the terminal sulfur anions in high-order polysulfides. Their computational and our experimental results hence complement each other well.

As discussed above, we examined the electrochemistry of these binders in Li—S cells using porous hollow carbon spheres (PHCSs) as sulfur hosts. Owing to their high surface areas, carbon spheres enable a large fraction of sulfur to be loaded in the cathode, while maintaining good electronic conductivity. Sulfur was loaded into these spheres via melt-diffusion at 160° C., yielding 75 wt. % sulfur in the resulting composite materials, “S-PHCSs”, which is the maximum loading achievable for nanostructured carbon spheres.

Constructing a compact cathode via the traditional slurry process comprises evenly distributing the binders on the current collector. The conductive carbons (Super P® and carbon nanotubes) and active composite material (S-PHCSs) in the casting solvent need to be at a concentration to achieve a viscosity that ensures effective mixing, dispersion, and penetration of the binder material into the electrode. The hydrophilic character of these cross-linked polyelectrolyte binders provides excellent compatibility with water. Thus, a binary solvent system comprised of water and DMF was used for the two cross-linked polymers, while only DMF was used to prepare the PVDF casting solution. DMF homogenizes the non-polar S-PHCSs and carbon, while water ensures that the binder is well dispersed in the solvent. The S-PHCS composite, carbon additives, and the binder solutions were mixed and cast on both sides of P50 carbon paper via a layer-by-layer deposition technique to maximize the packing efficiency.

Our use of P50 as a current collector was dictated by several factors. In comparison with a Al-foil current collector, the micron-sized carbon fibers provide a 3D electronically conductive network that enables excellent electron transfer to the adherent cathode materials. The fiber structure allows sufficient electrolyte penetration—without compromising the overall sulfur content—to overcome mass-transport barriers in thick electrodes. In particular, though, the nature of the carbon paper enables measurement of the intrinsic electrode's mechanical properties, which was the focus of the present study. Furthermore, Al and P50 current collectors have a similar average areal mass of 4.5 and 5.0 mg·cm⁻², respectively. Therefore, from a gravimetric point of view, the overall sulfur content is not sacrificed. High-magnification SEM images and EDX analysis of the representative poly(AETMAC-co-EGDA)-based sulfur electrode showed that not only were the materials evenly distributed onto the P50 carbon paper, but also that the overall structure of the cathode exhibited sufficient porosity for electrolyte penetration. These properties do not exist for Al foil, and are vital to showcase the properties of the binder itself—namely its mechanical properties that enable long-term cycling even at high sulfur loading as shown below.

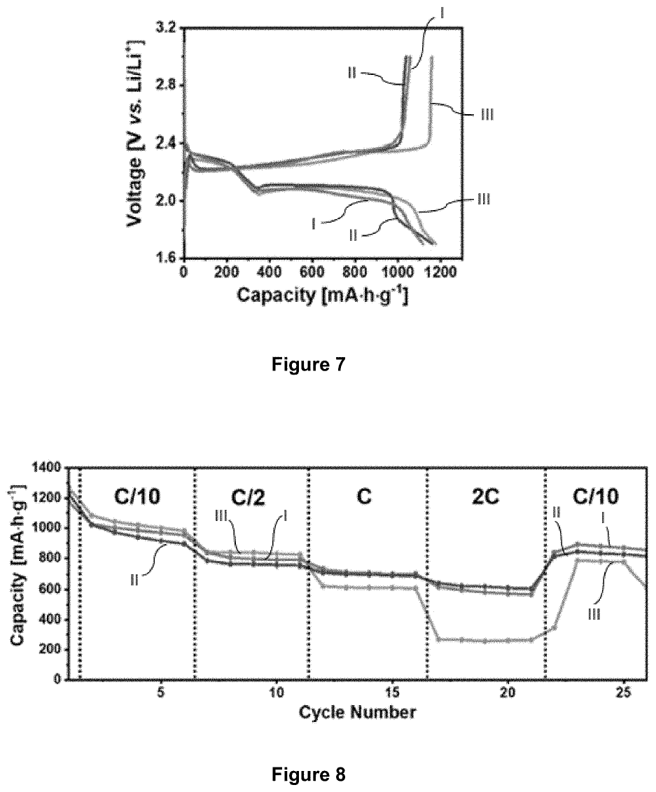

The electrochemical performance of the resulting Li—S cells was examined by galvanostatic cycling and the results are summarized in FIGS. 7-9. Electrodes with low loadings of ˜3.5 mg·cm⁻² (based on sulfur) were first fabricated with the different polymeric binders described herein to rank the impact of the functional group and the mechanical properties on sulfur utilization and cycling stability before examining high loading Li—S cells. During the first activation cycle at C/20 (1C=1675 mA·h·g⁻¹), the poly(AETMAC-co-EGDA), poly(DADMAC-co-EGDA), and PVDF based electrodes exhibited similar discharge capacities of 1115, 1160, and 1175 mA·h·g⁻¹, respectively (FIG. 7). The electrochemical profiles of these cathodes exhibit a typical two-plateau discharge profile, corresponding to the formation of high-order polysulfides at ˜2.3 V and nucleation/precipitation of insoluble Li₂S₂/Li₂S at ˜2.1 V vs. Li/Li+. The sloping region below ˜1.8 V (curve II) is most likely due to negative electrode passivation from slight reduction of the LiNO₃ additive, which is typical for the first activation cycle.

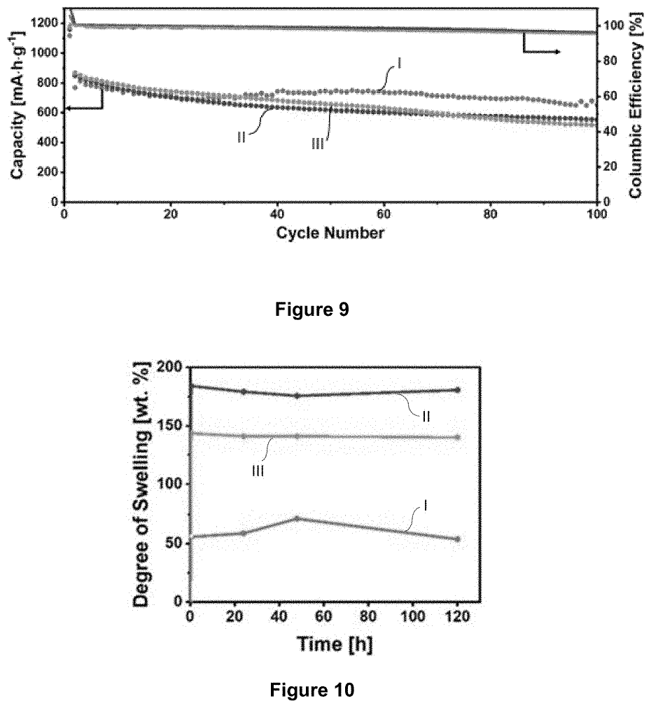

FIG. 8 illustrates the relative discharge capacities of these cathodes at different C-rates. As shown, the Li—S cells fabricated with either poly(AETMAC-co-EGDA) or poly(DADMAC-co-EGDA) exhibited a reversible capacity of ˜600 mA·h·g−1 at 2 C. The capacity recovered to ˜850 mA·h·g⁻¹ when the C-rate reverted to C/10. In sharp contrast, the capacity of the PVDF-based Li—S cell dropped to ˜250 mA·h·g⁻¹ at 2 C and showed capacity fluctuation during subsequent cycling at C/10. We note that the carbon spheres only provide physical confinement for the polysulfides by limiting diffusion; these sulfur species can be ultimately be solubilized in the electrolyte. For this reason, and as illustrated in FIG. 9, the electrode with the PVDF binder only retains 52% capacity over 100 cycles, while electrodes prepared with the poly(AETMAC-co-EGDA) and poly(DADMAC-co-EGDA) binders retained 85% and 65% of their initial capacities, respectively. Their high concentration of ammonium cations forms a 3D network of interacting sites to more effectively bind with the polysulfide anions. Nonetheless, the behavior of these two cross-linked binders diverges after 30 cycles. Although the capacity of the cathode fabricated with poly(DADMAC-co-EGDA) continued to decline past this point, that of poly(AETMAC-co-EGDA) remained relatively constant. These binders do not display a drastic difference in polysulfide adsorptivity and share the same cross-linker with an optimized cross-linking density. The underlying difference lies in their mechanical properties as we show below.

The swellability of the polymers was studied by soaking them in a dioxolane/dimethyloxyethane solution (DOL:DME, 1:1 v/v). The change in weight corresponding to solvent uptake was monitored after extracting the solid at different contact times. The weight gain shown in FIG. 10 gives a rough estimate of the polymer-solvent interactions. The swelling ratio was calculated according to the equation (W_{wet}− W_{dry})/W_{dry}, where Wdry is the weight of the dry polymer and W_{wet} is the weight after soaking.

Poly(AETMAC-co-EGDA) was fabricated with a lower cross-linker ratio (4:1 molar ratio of AETMAC:EGDA) and swelled far less (˜60 wt. %) than PVDF (˜140 wt. %), but also less than poly(DADMAC-co-EGDA) (˜180 wt. %), which was prepared with a higher cross-linker ratio of 2:1 mole ratio of DADMAC:EGDA. This is attributed to the large chain transfer constant of the allylic DADMAC monomers, which interferes with the growth of an extended network. It results in a much looser network and higher swellability compared to the AETMAC network. The lower degree of swelling and higher chemical stability observed in poly(AETMAC-co-EGDA) are important binder characteristics to maximize the acid-base interactions between ammonium chloride and lithium polysulfide. This is particularly important for high sulfur loading cathodes, where cell performance is strongly dependent on the amount of liquid electrolyte available. While a moderate degree of polymeric binder swelling can result in superior electrochemical performance, the high swelling observed for both PVDF and poly(DADMAC-co-EGDA) leads to the uptake of significant amounts of liquid electrolyte. Consequently, the polymer no longer binds the electrode components. Furthermore, in the case of poly(DADMAC-co-EGDA), strong swelling can weaken the interactions between the ammonium chloride and lithium polysulfides, which hinders the entrapment of polysulfides. Thus, poly(DADMAC-co-EGDA) adsorbs less Li2Sn than poly(AETMAC-co-EGDA), as also illustrated in FIG. 6.

The sulfur electrode fabricated with poly(AETMAC-co-EGDA) also better supports the continuous stress during cycling. The tensile strengths as well as the Young's and toughness moduli of the cathodes (cut into rectangles 3″×1″) were evaluated on a tensometer as described above. The force and the displacement recorded in real time were used to calculate the stress (σ) according to the following equation (1):

$$σ = \frac{{F}_{z} - {F}_{{z}_{0}}}{A}$$

where F_{z} and F_{z0} are the forces experienced by the electrode during the experiment and at the beginning of the experiment, respectively, and A is the cross-sectional area of the electrode. For a 1″ width P50 carbon paper with a sulfur loading of 3.5 mg·cm⁻², the cross-sectional area of the specimen was 7 mm². The strain (E) was calculated according to the following equation (2):

$$ɛ = \frac{{x}_{z} - {x}_{{z}_{0}}}{{x}_{{z}_{0}}} \times 100 \%$$

where x_{z} and x_{z}_{⁰} are the distances between the two grip heads while the electrode was being stretched.

FIG. 11 illustrates the stress-strain curves for these electrodes and shows a profile typical of fiber nanocomposites: a linear curve that obeys Hooke's law, followed by a sudden drop in stress. This sharp decrease in stress corresponds to the tearing of the electrode composite when the maximum stress is exceeded and provides the value of the tensile strength. The poly(AETMAC-co-EGDA)-based electrode exhibited the highest tensile strength (7.0 GPa), compared to the electrodes prepared from poly(DADMAC-co-EGDA) (5.7 GPa) and PVDF (3.8 GPa). Furthermore, the Young's modulus of the electrode fabricated from the two cross-linked binders was found to be very similar (˜4.5 GPa), and greatly improved over the PVDF binder (2.5 GPa).

The cross-linked binders form a 3D network that also improves the connectivity between the cathode components (S-PHCSs and carbon additives) and the carbon fibres in the P50 carbon paper. This material entanglement decreases the likelihood of delamination during cycling and stiffens the electrode structure, thus improving the tensile strength and Young's modulus.

Toughness (U) is an intrinsic property that describes the energy of mechanical deformation per unit volume prior to fracture. It provides a metric to gauge the durability of the electrode, and is calculated by integrating the area under the stress-strain curve as described by the following equation (3):

$$U = {\int }_{{x}_{{z}_{0}}}^{{x}_{{z}_{r}}} σ \cdot \frac{{x}_{z} - {x}_{{z}_{0}}}{{x}_{{z}_{0}}} {dx}_{z}$$

Where (x_{z}−x_{z}_{⁰})/x_{z}_{⁰} is the strain that the electrode experiences and x_{zr} is the distance between the two grip heads when the electrode ruptures.

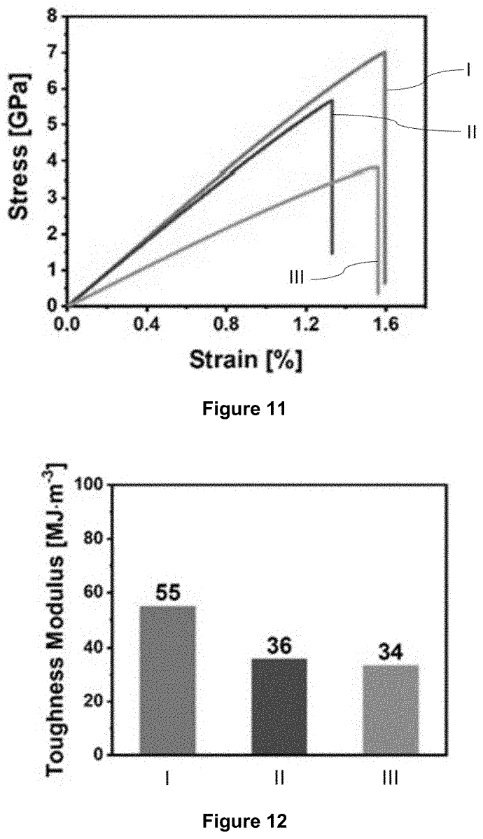

FIG. 12 illustrates the relative toughness as measured for sulfur electrodes with different binders. The electrode prepared with poly(AETMAC-co-EGDA) exhibited the highest value of 55 MJ·m⁻³. Both poly(DADMAC-co-EGDA) (36 MJ·m⁻³) and PVDF (34 MJ·m⁻³) exhibit similar but much lower toughness. This suggests that at the same sulfur and carbon additive loading, poly(AETMAC-co-EGDA) forms a more resistant 3D network with the S/C composite providing superior mechanical bonding compared to the other two polymers.

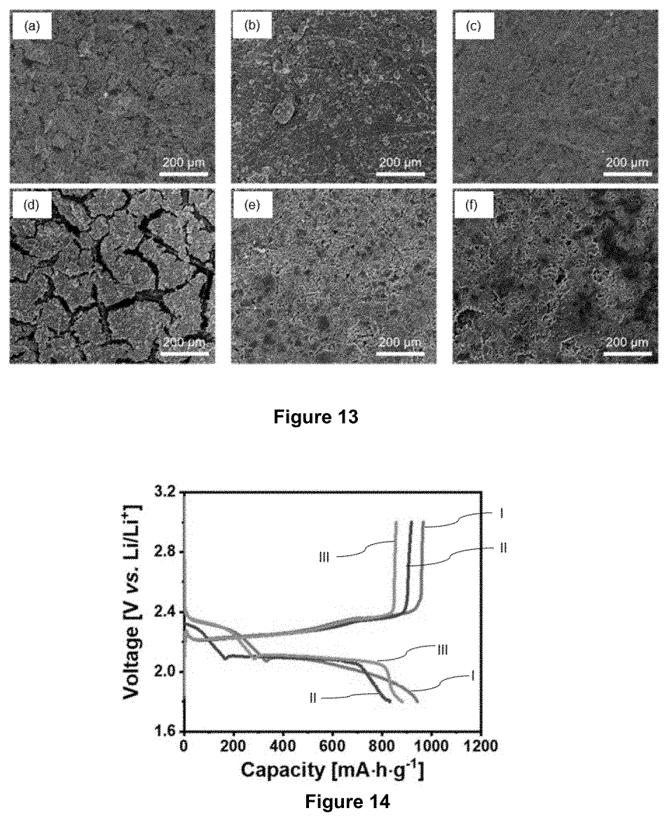

SEM studies were carried out before cycling (FIGS. 13a to 13c) and after cycling (FIGS. 13d to 13f) to validate the impact of the mechanical properties in maintaining cathode architecture. Cross-sectional areas of these electrodes were also examined to investigate electrode material delamination from the current collector. The low-magnification SEM images in FIGS. 13a to 13c show that all three electrodes were relatively flat and free of cracks. Furthermore, the cross-sectional SEM image analysis showed that most of the cathode materials penetrate a few tens of microns into the carbon fiber matrix. Upon cycling, the PVDF-based electrode shows large cracks, as shown in FIG. 13d. This was accompanied by severe delamination of the cathode material from the P50 current collector, as was also observed in the cross-sectional area analysis upon cycling at C/5 for 10 cycles. We attributed this to the fact that PVDF exhibits the lowest tensile strength, Young's modulus, and toughness among all the binders studied, and thus cannot support drastic volume changes upon cycling.

On the other hand, electrodes cast with the poly(DADMAC-co-EGDA) binder exhibited fewer cracks and less material delamination under identical cycling conditions (see FIG. 13e). This was attributed to the higher tensile strength and Young's modulus resulting from the incorporation of the cross-linker. Furthermore, the improved capacity retention benefitted from the large number of active sites in the polymer network, providing additional polysulfide chemisorption. However, the highly swollen poly(DADMAC-co-EGDA)-based electrode network was unable to maintain uniform interaction with lithium polysulfides, causing the capacity of the electrode to diminish rapidly, as illustrated in FIG. 9.

As shown in FIG. 13f, the architecture of the poly(AETMAC-co-EGDA)-based electrode remained intact upon deep cycling. This further confirms that the individual S/C composite particles were strongly bound to the current collector. In summary, the low swelling capability of poly(AETMAC-co-EGDA) ensures sufficient interactions between its ammonium cations and the polysulfide anions. This cross-linked polymer also conveys a higher tensile strength, stiffness, and toughness to the electrode, for increased tolerance to delamination, and favors electrode durability.

To further correlate the electrochemical performance with the mechanical properties of the sulfur electrodes fabricated with the binders described herein, electrochemical impedance spectroscopy (EIS) studies were performed during cycling. The interfacial resistance of both the PVDF- and poly(DADMAC-co-EGDA)-based electrodes increased during the first 50 cycles. This is in strong agreement with the SEM analysis, discussed earlier, that suggests that the architecture of these electrodes slowly deteriorates as a result of their poorer physical properties (see FIGS. 11 and 12). In contrast, the EIS of the poly(AETMAC-co-EGDA)-based electrode remained largely unchanged. This indicates that while both poly(DADMAC-co-EGDA) and poly(AETMAC-co-EGDA) contain ammonium cation subunits that engage in charge transfer interactions with the polysulfide anions, the latter polymer provides superior mechanical binding strength between the cathode components as well as with the current collector, preserving the electrode integrity during cycling.

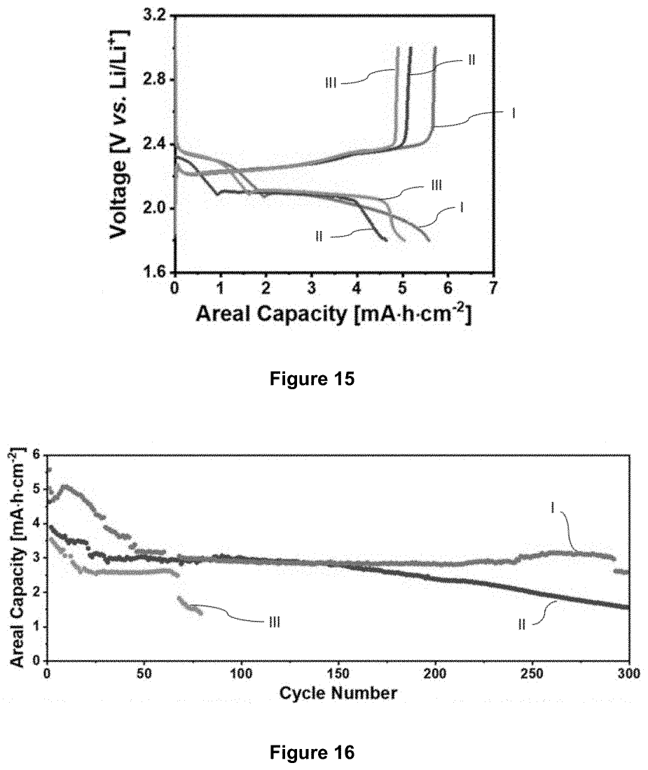

High sulfur loading (˜6.0 mg·cm⁻²) electrodes were fabricated using these binders as further proof-of-concept. All the cathodes were maintained at open circuit voltage for 4 hours prior to cycling, to allow equilibrium swelling of the binder. Due to the electrode thickness, these cathodes were conditioned at a low current density of C/50 for one cycle before being subjected to long-term cycling at C/10. As shown in FIG. 14, all of the cathodes exhibited a similar initial discharge capacity between 800 and 1000 mA·h·g⁻¹. Initial areal capacities were obtained of 5.57, 5.24, and 4.64 mA·h·cm⁻² for electrodes fabricated with poly(AETMAC-co-EGDA), poly(DADMAC-co-EGDA), and PVDF respectively and these are illustrated in FIG. 15. The initial areal capacities of the cathodes in this study are not as high as for some recently reported 3D architecture cathodes, but we note that those electrodes were studied over only 100 cycles using a catholyte-type cell (i.e., a high electrolyte:sulfur ratio). Considering the relatively low electrolyte:sulfur (7:1) ratio used in our study, the approach is promising for higher energy density Li—S cell applications.

As shown in FIG. 16, long-term cycling of the electrodes over 300 cycles provides further insight into the ability of the binder to stabilize the cycling of high loading Li—S cells. The PVDF-based electrode showed fluctuation in capacity with rapid fading. The capacity drop after 60 cycles indicates cumulative surface passivation from randomly precipitated Li₂S/S₈ particles on the electrode surface, which becomes pronounced at the 79^{th} cycle and causes cell death. However, the sulfur cathodes fabricated with poly(DADMAC-co-EGDA) and poly(AETMAC-co-EGDA) exhibited good reversible discharge areal capacities over the first 150 cycles. The gradual capacity decay experienced on continued cycling (>150 cycles) of the poly(DADMAC-co-EGDA)-based sulfur cathode was ascribed to its high degree of swelling, as well as to the low tensile strength and toughness of the polymer. At such a high degree of swelling, the ammonium cations may interact with the solvent molecules as much as with the polysulfides. The poly(AETMAC-co-EGDA)-based electrode reached a higher capacity of 5 mA·h·cm⁻² (after the first few conditioning cycles needed to fully wet the electrode) and ultimately stabilized at ˜3 mA·h·cm⁻² on the 50^{th} cycle. Most importantly, capacity retention was excellent over the latter cycling period.

### CONCLUSIONS

A multifaceted approach has been demonstrated for the fabrication of stable and high loading sulfur cathodes by utilizing a cross-linked polymeric binder which exhibits promising mechanical properties and carries quaternary ammonium groups. These binders form a 3D network with active sites, leading to direct charge-transfer interactions with polysulfides that greatly improves the electrochemical performance of the cell as compared with a traditional PVDF binder.

Of the polymeric binders studied, the poly(AETMAC-co-EGDA) binder was found to have superior characteristics over the poly(DADMAC-co-EGDA) binder. Although both binders have similar chemical functionality, the tighter polymer network of poly(AETMAC-co-EGDA), compared to poly(DADMAC-co-EGDA), reduces electrolyte swelling and increases the tensile strength, Young's modulus, and toughness. These factors are important for delamination tolerance. As a result, good capacity retention over 300 cycles for compact thick electrodes (6.0 mg·cm⁻²) was exhibited in Li—S cells with a moderate electrolyte-sulfur ratio.

At least three advantages are achieved with the binders described herein. First, strong chemisorption by the binder allows the use of simple carbon-based host materials, although more advanced (i.e, N, S-doped) carbons are expected to show even better properties. Second, the integrity of the cathode architecture can be maintained due to the flexibility which the polymeric binder provides. Third, traditional slurry processes can be used to cast the cathode material onto the current collector. Other advantages of the binders and cathodes described herein would be apparent to persons skilled in the art. These advantages are realized by the binders described herein that have ammonium functional groups. Two of such binders have been described herein. It is expected, however, that other binders with ammonium functional groups, such as ammonium chloride functional groups, will provide the same advantages and benefits as described above.

Although the above description includes reference to certain specific embodiments, various modifications thereof will be apparent to those skilled in the art. Any examples provided herein are included solely for the purpose of illustration and are not intended to be limiting in any way. Any drawings provided herein are solely for the purpose of illustrating various aspects of the description and are not intended to be drawn to scale or to be limiting in any way. The scope of the claims appended hereto should not be limited by the preferred embodiments set forth in the above description but should be given the broadest interpretation consistent with the present specification as a whole. The disclosures of all prior art recited herein are incorporated herein by reference in their entirety.

1: A cathode for a lithium-sulfur cell, the cathode comprising:
one or more cathode active materials, comprising sulfur and/or sulfur-based materials;
one or more conductive materials; and,
at least one binder, wherein the binder comprises a polymeric material having ammonium functional groups.

2: The cathode of claim 1, wherein the ammonium functional groups comprise ammonium chloride groups.

3: The cathode of claim 2, wherein the ammonium functional groups comprise trimethylammonium and/or dimethylammonium groups.

4: The cathode of claim 1, wherein the binder comprises a polymer of monomers and a cross-linking agent, and wherein the monomers comprise the ammonium functional groups.

5: The cathode of claim 1, wherein the binder comprises:
(i) a polymer formed from [2-(acryloyloxy)ethyl]trimethylammonium chloride monomers and a cross-linker; and/or
(ii) a polymer formed from diallyldimethylammonium chloride monomers and a cross-linker.

6: The cathode of claim 1, wherein the binder comprises:
(i) a polymer formed from [2-(acryloyloxy)ethyl]trimethylammonium chloride monomers cross-linked with ethylene glycol diacrylate; and/or
(ii) a polymer formed from diallyldimethylammonium chloride monomers cross-linked with ethylene glycol diacrylate.

7: The cathode of claim 6, wherein the one or more conductive materials comprise carbon and/or carbon-based materials.

8: The cathode of claim 6, wherein the one or more conductive materials comprise carbon black, carbon spheres, and/or carbon nanotubes.

9: A lithium-sulfur battery comprising a lithium anode, an electrolyte, and a cathode according to claim 6.

10: A cathode composition for forming a cathode for a lithium-sulfur battery, the cathode material comprising:
one or more cathode active materials, comprising sulfur and/or sulfur-based materials;
one or more conductive materials; and,
at least one binder, wherein the binder comprises a polymeric material having ammonium functional groups.

11: The cathode composition of claim 10, wherein the ammonium functional groups comprise ammonium chloride groups.

12: The cathode composition of claim 11, wherein the ammonium functional groups comprise trimethylammonium and/or dimethylammonium groups.

13: The cathode composition of claim 10, wherein the binder comprises a polymer of monomers and a cross-linking agent, and wherein the monomers comprise the ammonium functional groups.

14: The cathode composition of claim 10, wherein the binder comprises:
(i) a polymer formed from [2-(acryloyloxy)ethyl]trimethylammonium chloride monomers and a cross-linker; and/or
(ii) a polymer formed from diallyldimethylammonium chloride monomers and a cross-linker.

15: The cathode composition of claim 10, wherein the binder comprises:
(i) a polymer formed from [2-(acryloyloxy)ethyl]trimethylammonium chloride monomers cross-linked with ethylene glycol diacrylate; and/or
(ii) a polymer formed from diallyldimethylammonium chloride monomers cross-linked with ethylene glycol diacrylate.

16: The cathode composition of claim 15, wherein the one or more conductive materials comprise carbon and/or carbon-based materials.

17: The cathode composition of claim 15, wherein the one or more conductive materials comprise carbon black, carbon spheres, and/or carbon nanotubes.

18: The cathode of claim 1, wherein the one or more conductive materials comprise carbon and/or carbon-based materials.

19: The cathode of claim 1, wherein the one or more conductive materials comprise carbon black, carbon spheres, and/or carbon nanotubes.

20: A lithium-sulfur battery comprising a lithium anode, an electrolyte, and a cathode according to claim 1.
